(19) United States
(12) Patent Application Publication
(10) Pub. No.: US 2009/0321079 A1
(43) Pub. Date: Dec. 31, 2009

(54) POWER LINE COMMUNICATION SYSTEM

(75) Inventor: Gerald Ian Robinson, Bristol (GB)

Correspondence Address: BRACEWELL & GIULIANI LLP, P.O. BOX 61389, HOUSTON, TX, 77208-1389, US

(73) Assignee: VETCO GRAY CONTRLS LIMITED, BRISTOL (GB)

(21) Appl. No.: 12/307,445

(22) PCT Filed: Jul. 3, 2007
(86) PCT No.: PCT/GB07/02482

§ 371 Date: Feb. 20, 2009

(30) Foreign Application Priority Data
Jul. 8, 2006 (GB) 0613623.8

(51) Int. Cl. E21B 43/01; G05B 11/01

(52) U.S. Cl. 166/335; 340/310.11

(57) ABSTRACT

A hydrocarbon production installation comprising a surface station and an underwater hydrocarbon extraction facility, the surface station and extraction facility being electrically linked via an umbilical cable, the installation further comprising means for transmitting first and second components of a communications signal and power from the surface station to the extraction facility via the umbilical cable. The transmitting means including means for passing the communications components through the umbilical cable in a balanced manner. The transmitting means further comprises means for transmitting the power through the umbilical cable superimposed on the communications components, and the facility comprises means for receiving the communications components and separating the power from the communications components.

This invention relates to communications and power transmission apparatus for transmitting both communications signals and electrical power from a source to a location remote from the source and a hydrocarbon production installation utilizing such apparatus.

Control of an offshore fluid extraction well is typically effected from the shore or from an offshore platform via an umbilical. The umbilical typically carries hydraulic and electrical power, and communication for control and monitoring of the well. Modern systems use fibre optic communication channels which provide high quality and high data rates. Currently, since the use of fibre optic communications does not yet have a history of long term reliability, well operators demand a back up wire communications system, be it at a lower data rate. In order to simplify the umbilical and reduce its costs, the control communication is typically achieved by superimposing the control data on the power wires at the source and extracting it at the well i.e. Communications on Power (COP). Although this technique has been made to work successfully, in the case of long umbilical lengths, e.g. 120 Km, there are technical problems with the conventional approach. They are:—
a) Because of the long umbilical length (e.g. 120 Km) and in order to keep cable costs down, the cable transmits power at high voltage and low current. The major problem in designing COP systems, which typically use frequency division multiplexing, is keeping the power out of the communications. Filters which reject the fundamental frequency are easy to design since they can be part of the signal filter. However, the power channel can also generate harmonics and some of them will be in the communications band, so the signal filter cannot remove them without removing the signal as well. Thus they must be removed by power filters.
b) Because of the length of the cable, its attenuation is very large at high frequencies, typically greater than 70 dB. As a result, signalling frequencies are quite low, typically below 10 kHz. The consequence of this is that separation between power and communications frequencies is small, and multiplexing filters have to develop sufficient attenuation over a shorter frequency range. Power filters have to be designed with a low cut-off frequency and this, coupled with the high voltages involved, means large values and bulky components.
c) Filters which remove communications band harmonics from the power source (and load) exhibit a frequency response which varies with load impedance. In particular, a heavy load will naturally depress the output, even in theoretical, lossless filters. This degrades the voltage regulation of the system, reducing its ability to deliver power.

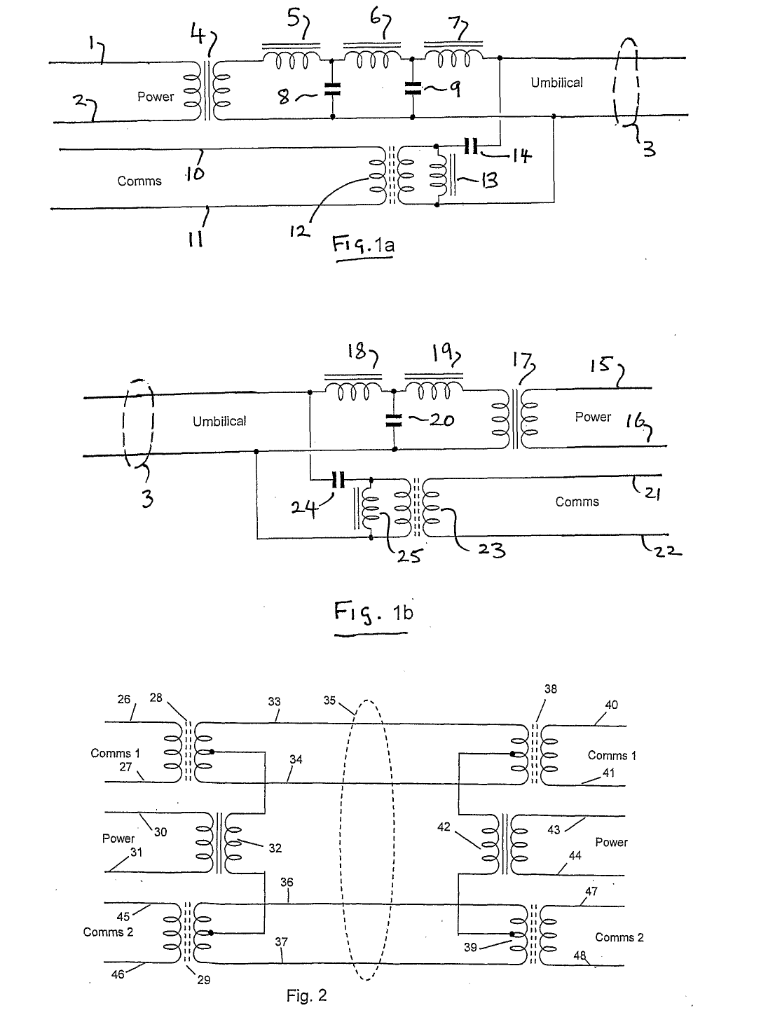

FIGS. 1a and 1b show how a conventional COP system can be implemented. FIG. 1a shows how a communications signal is added to the power at the source end of an umbilical (i.e. the combiner) and FIG. 1b how the communications signal is extracted at the well end (i.e. the splitter).

More particularly, referring to FIG. 1a, power on lines 1, 2 at a shore-based installation or an offshore platform is supplied to an umbilical 3 via a transformer 4 and a power filter. The power filter comprises three series-connected inductors 5, 6 and 7 and two parallel-connected capacitors 8 and 9. Also at the shore-based installation or offshore platform, a communications signal on lines 10, 11 comprising control data is applied to umbilical 3 via a transformer 12 and a communications filter. The communications filter comprises a parallel-connected inductor 13 and a series-connected capacitor 14. Referring to FIG. 1b, at the well, power is supplied from the umbilical 3 to lines 15,16 via a power filter and a transformer 17. The power filter comprises two series-connected inductors 18 and 19 and a parallel-connected capacitor 20 and the communications signal is supplied to lines 21, 22 and via a transformer 23 and a communications filter. The communications filter comprises a series-connected capacitor 24 and a parallel-connected inductor 25.

The power filter components shown in FIGS. 1a and 1b must be designed to cope with the voltages and currents associated with the power circuits. Furthermore, their cut-off frequencies could well be as low as 100 Hz which means, typically, 3 μF capacitors rated at 3 kV and 0.8 H inductors designed to carry 10 A. These are large components and the capacitors are difficult to source. The communications filter inductors are smaller but the capacitors are at least 1 μF and need to be rated at the full high voltage.

It is an aim of the present invention to provide means for enabling transmission of both communications signals and power from a source, such as a surface station of a hydrocarbon production installation, to a remote location, such as an underwater hydrocarbon extraction facility, whilst mitigating the problems identified above.

An example of a system for transmitting both communications signals and power using a phantom channel is known from U.S. Pat. No. 4,173,714 (Bloch), which concerns its use in a telephone network.

In accordance with the present invention there is provided apparatus and a method as set out in the accompanying claims.

The invention will now be described with respect to the accompanying drawing, in which:

FIG. 1a shows a known transmitting arrangement;

FIG. 1b shows the receiving end of the above arrangement; and

FIG. 2 shows a circuit diagram of an embodiment in accordance with the present invention.

FIG. 2 shows an embodiment of the present invention. At a surface-based station, e.g. shore-based or at an offshore platform, communications signals on lines 26, 27 and on lines 45, 46 for a subsea well or wells are supplied to each of two communications input transformers 28 and 29 respectively and power on lines 30 and 31 is supplied to a power input transformer 32. The secondary winding of transformer 28 is connected across a pair of wires 33, 34 in an umbilical 35 and the secondary winding of transformer 29 is connected across a second pair of wires 36, 37 in the umbilical 35. Thus the communications signal is split into two halves, each half being carried by a respective one of the pairs 33, 34 and 36, 37, these pairs being galvanically isolated from each other.

One end of the secondary winding of transformer 32 is connected to the mid-point of the secondary winding of transformer 28, the other end of the secondary winding of transformer 32 being connected to the mid-point of the secondary winding of transformer 29.

At an underwater hydrocarbon extraction facility, e.g. a subsea well or well complex, the primary winding of a power output transformer 38 is connected across the pair of wires 33, 34, the primary winding of a power output transformer 39 being connected across the pair of wires 36, 37. The secondary windings of transformers 38 and 39 are connected across lines 40, 41 and 47, 48 respectively to provide two communications channels for the facility. Also at the facility, one end of the primary winding of a power output transformer 42 is connected to the mid-point of transformer 38, the other end of the primary winding of transformer 42 being connected to the mid-point of transformer 39. The secondary winding of transformer 42 is connected across lines 43, 44 to provide power for the facility.

In a conventional COP system, the power and communications are carried on a single pair whilst the example of the present invention requires two pairs. However, power is carried on both pairs so either twice as much power can be carried, for the same wire size in the umbilical, or the four wires can be smaller. Communication over very long distances can generally only be accomplished at low data rates. This causes great difficulty for conventional COP systems because as the difference between communications and power frequencies becomes smaller, separating communications signal from power becomes increasingly difficult. The system according to the present invention requires much simpler filtering because of the inherent isolation between the power and communications channels. Furthermore, two communications channels are provided. Typically the system supplies communications signals to a well complex rather than one well, so in practice, to increase the rate at which well data is collected and control commands issued, communications signals might be supplied for example to four wells via one pair of wires and to another four via the other pair. Thus, data rates can be halved without affecting field data update rates, to extend the distance over which communications can be achieved.

If the centre taps of each of the transformers 28, 29, 38 and 39 are perfect so that crosstalk between the pairs is zero, then there is complete isolation between the power and the communications signal circuits. In practice, isolation will not be total but will, typically, be around 50 dB. Again, in practice some filtering will be needed but the problem will be at least two orders of magnitude less difficult than for conventional COP systems.

In the system of FIG. 2, the communications signal is split into two halves and each half is carried by one of two wire pairs. The two pairs are galvanically isolated from each other. The power is carried via a “phantom channel” as a common mode signal on each of the two communications pairs.

This invention eliminates the need for expensive, high voltage and bulky components and at the same time the new technique provides excellent common mode rejection, which, in tests, has demonstrated an isolation between power and signal of 80 dB or better. In practice 50 dB of isolation is expected.

As well as sending a communications signal to the hydrocarbon extraction facility, signals from the latter (e.g. from monitoring of the well) may be sent via the same path to the surface-based station and in that respect the communication could operate in a simplex mode, a duplex mode or in a semi-duplex mode (with communication in the two directions alternating with each other).

The foregoing description relates to an embodiment of the present invention only. It will be apparent to those skilled in the art that various modifications or alternatives are possible within the scope of the claims.

What is claimed is:

1. Communications and power transmission apparatus for transmitting both communications signals and electrical power from a source to a location remote from the source, comprising, at the source:
a power input connected to first and second power input transformers for feeding power to respective primary windings of said first and second power input transformers; and
a communications signal input,
and, at the remote location:
a power output connected to respective secondary windings of first and second power output transformers; and
a communications signal output,
wherein:
the secondary windings of the first and second power input transformers are respectively connected to the primary windings of the first and second power output transformers to form first and second galvanically-isolated circuits; and
the communications signal input is connected between centre-taps of the secondary windings of the first and second power input transformers, and the communications signal output is connected between centre-taps of the primary windings of the first and second power output transformers.

2. Apparatus according to claim 1, wherein the communications signal input is connected to a primary winding of a communications signal input transformer, a secondary winding of the communications signal input transformer being connected between the centre-taps of the primary windings of the first and second power input transformers.

3. Apparatus according to claim 1, wherein the communications signal output is connected to a secondary winding of a communications signal output transformer, a primary winding of the communications signal output transformer being connected between the centre-taps of the primary windings of the first and second power output transformers.

4. A hydrocarbon production installation comprising apparatus according to claim 1, wherein the source is at a surface station, and the remote location is an underwater hydrocarbon extraction facility, the surface station and extraction facility being electrically linked via an umbilical cable.

5. A hydrocarbon production installation according to claim 4, wherein the first and second galvanically-isolated circuits are substantially located within the umbilical cable.

6. A hydrocarbon production installation comprising a surface station and an underwater hydrocarbon extraction facility, the surface station and extraction facility being electrically linked via an umbilical cable, the installation further comprising means for transmitting both a communications signal and power from the surface station to the extraction facility via the umbilical cable, the transmitting means including means for splitting the power into first and second components at the station, for passing both components through the umbilical cable in a balanced manner, and for recombining the components at the facility, the transmitting means further comprising means for transmitting the communications signal through the umbilical cable superimposed on the power components and communications signal at the facility.

7. A method of transmitting both a communications signal channel and a power channel from a surface station of a hydrocarbon production installation to an underwater hydrocarbon extraction facility via an umbilical cable, comprising the steps of: splitting the power into first and second components at the station; transmitting the components through the umbilical cable in a balanced manner to the extraction facility; transmitting the communications signal through the umbilical cable superimposed on the power components; recombining the components at the facility; and separating the communications signal at the facility.
